(19) United States
(12) Patent Application Publication
(10) Pub. No.: US 2006/0049982 A1
(43) Pub. Date: Mar. 9, 2006

(54) Method of and system for reducing a time to fix in a location-enabled receiver

(75) Inventor: Graham Wells, Kingsclere (GB)

Correspondence Address: JENKENS & GILCHRIST, PC, 1445 ROSS AVENUE, SUITE 3200, DALLAS, TX, 75202, US

(73) Assignee: Telefonaktiebolaget L M Ericsson (publ), Stockholm (SE)

(21) Appl. No.: 11/145,158

(22) Filed: Jun. 3, 2005

Related U.S. Application Data
(60) Provisional application No. 60/607,176, filed on Sep. 3, 2004.

(51) Int. Cl. G01S 5/14

(52) U.S. Cl. 342/357.1; 342/357.15

(57) ABSTRACT

A location-enabled wireless device includes a wireless receiver and a positioning-signal receiver. The wireless device further includes an oscillator adapted to output a reference-frequency signal to the wireless receiver and the positioning-signal receiver and a detector adapted to output a control signal upon detection of at least one of a frequency error and a phase error between wireless signals and the reference-frequency signal. This Abstract is submitted with the understanding that it will not be used to interpret or limit the scope or meaning of the claims.

### CROSS-REFERENCE TO RELATED APPLICATIONS

This patent application claims priority from and incorporates by reference the entire disclosure of U.S. Provisional Patent Application No. 60/607,176, which was filed on Sep. 3, 2004.

### BACKGROUND OF THE INVENTION

1. Technical Field

The present invention relates in general to Global Positioning System (GPS) devices and more particularly, but not by way of limitation, to a method and apparatus within a location-enabled wireless device for reducing a time required by the wireless device to provide an accurate geographical location.

2. History of Related Art

With the advent of Global Positioning Systems (GPS), the art of locating individuals or devices has been greatly enhanced. A GPS receiver onboard a device typically retrieves GPS signals from at least three orbiting GPS satellites. These GPS signals are converted into location coordinates that are either stored in the device's memory or transmitted to a base station via, for example, radio, cellular, or paging technology. The base station may then determine the location by, for example, plotting the coordinates on a map either manually or on a computer mapping system.

Recently, new applications of GPS technology in wireless devices have emerged imbedding GPS receivers in, for example, mobile stations for communicating the location of the receiver. These applications require a GPS receiver to operate in harsh signal environments, where GPS signal levels may be greatly attenuated. Thus, a GPS signal which may be easily acquired in the open becomes progressively harder to acquire when the GPS receiver is, for example, under foliage, in a vehicle, or in a building. Detecting attenuated signals requires each correlation to be performed over a relatively long time. The performance of the GPS receiver is further affected by a frequency stability of an oscillator used to receive satellite signals. In some cases, GPS receivers utilize a temperature compensated crystal oscillator (TCXO) to provide a stable frequency source. TCXOs employ temperature models or characteristics to adjust output frequency as a function of temperature.

One objective of packaging GPS receivers and mobile stations together is to reduce their combined cost and size by sharing the same housing and power supply. However, in existing systems where a GPS receiver and a mobile station coexist in the same package, the GPS receiver and the mobile station usually share little functionality. For example, in many cases, the GPS receiver utilizes the TCXO to provide the stable frequency source, while the mobile station utilizes a voltage controlled oscillator (VCXO) as a reference oscillator for generating a reference frequency signal for use in modulating signals received from the base station. In other cases, the GPS receiver and the mobile station utilize the VCXO as a common reference oscillator for generating a reference frequency signal.

At startup, the GPS receiver typically acquires a set of navigational parameters from navigational signals from GPS satellites. Initialization of the GPS receiver often takes several minutes and is dependent upon how much information the GPS receiver already has. Most GPS receivers are programmed with almanac data, which describes expected satellite positions. The GPS receiver may also have information about the current time and general location information. The starting point of GPS receivers that have information related to the current time and general location may be referred to as “warm start.”

However, if the GPS receiver does not have knowledge of its own approximate location, current time, and satellite transmitted data, such as, for example, a navigation model, the GPS receiver may not be able to correlate signals from the GPS satellites fast enough to calculate its position quickly. The start point of GPS receivers with no information related to the current time and general location may be referred to as “cold start.”

The GPS receivers are typically required to collect several seconds of satellite data in order to determine a GPS-based clock time (e.g., timing information) from a satellite time to fix (TTF). TTF is the time required for a GPS device to provide an accurate geographical location to its user. The GPS device provides an accurate location by calculating a distance from the GPS device to a GPS satellite by measuring time-of-arrival of a signal. This may take several seconds (e.g., <10 s). The satellite data typically includes three sub-frames that have a duration of 6 seconds, with a repetition period of 30 seconds. However, if a clock in the GPS receiver is changed during reception of satellite data, the TTF will be extended.

### SUMMARY OF THE INVENTION

A location-enabled wireless device includes a wireless receiver and a positioning-signal receiver. The wireless device further includes an oscillator adapted to output a reference-frequency signal to the wireless receiver and the positioning-signal receiver. The location-enabled wireless device further includes a detector adapted to output a control signal upon detection of at least one of a frequency error and a phase error between wireless signals and the reference-frequency signal.

A method of reducing a time to fix in a location-enabled wireless device, the method includes receiving wireless signals, receiving positioning signals, and outputting a reference-frequency signal to a wireless receiver and a positioning-signal receiver. Responsive to detection of at least one of a frequency error and a phase error between wireless signals and the reference frequency signal, outputting a control signal. The control signal provides an indication that the reference-frequency signal is being updated.

### BRIEF DESCRIPTION OF THE DRAWINGS

A more complete understanding of the present invention may be obtained by reference to the following Detailed Description of Embodiments of the Invention, when taken in conjunction with the accompanying Drawings, wherein:

FIG. 1 illustrates a simplified view of a wireless network;

FIG. 2 illustrates a block diagram of a GSM-GPS mobile station;

FIG. 3 is a block diagram of a detector circuit in the mobile station of FIG. 2; and

FIG. 4 is a flow diagram of a process for reducing a time to fix.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims and the equivalents thereof.

It would be cost-effective for the GPS receiver to utilize the VCXO of the mobile station to provide a stable frequency source and to take into account the fact that the frequency of the VCXO is dependent on temperature and the mobile station receiver activity. The frequency of the VCXO may fluctuate due to heat generated by an amplifier that generates transmission power. Furthermore, if the mobile station continues in a speech communication mode for an extended period of time, the reference frequency signal from the VCXO may fluctuate due to changes in the ambient temperature of the mobile station. If the GPS receiver is using the VCXO of the mobile station, the GPS receiver must be made aware of any oscillator-characteristic changes (e.g., changes in frequency and/or phase) to ensure that the oscillator-characteristic changes do not interfere with decoding of satellite signals by the GPS receiver.

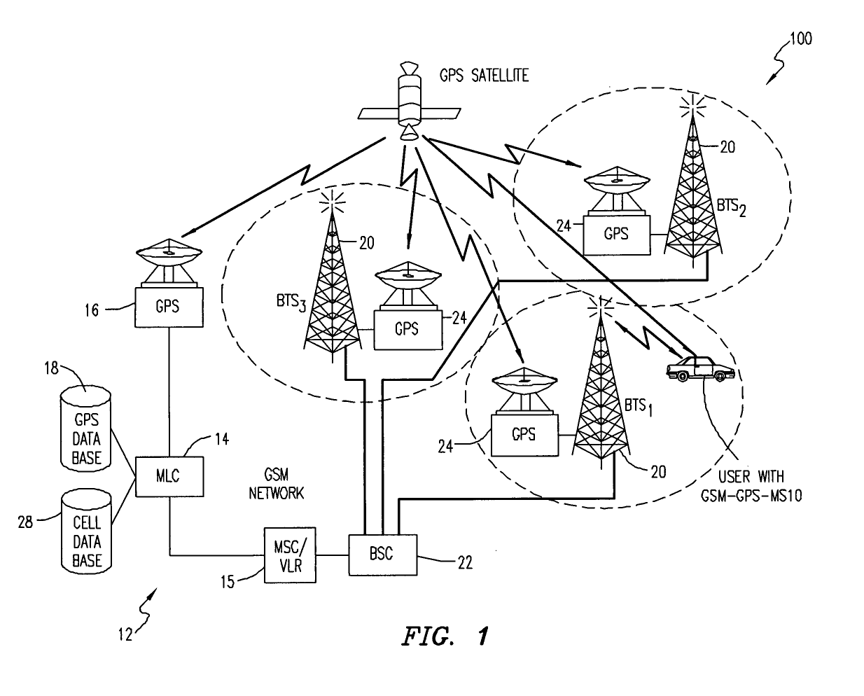

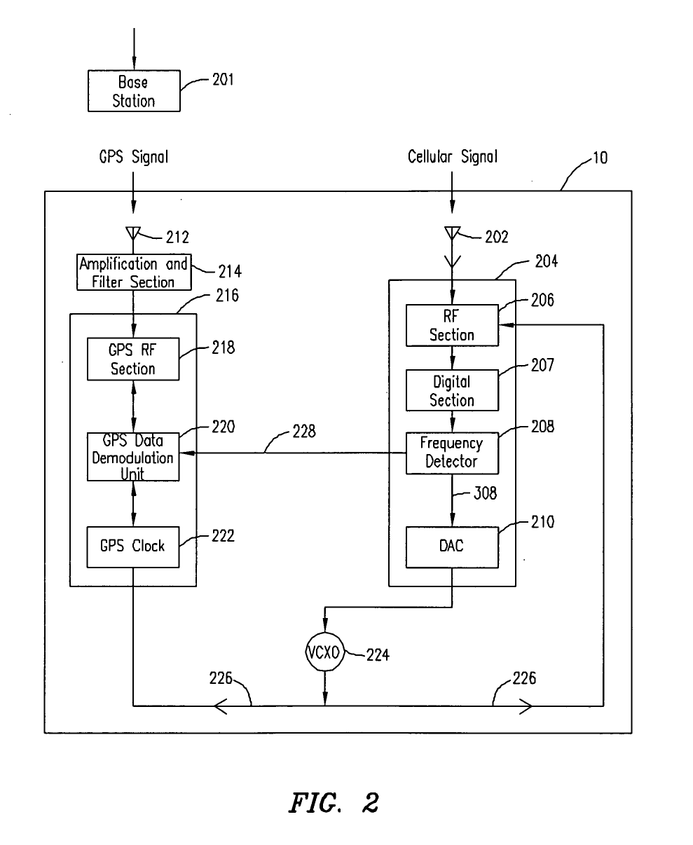

FIG. 1 illustrates a block diagram of a wireless network combined with a GPS system. The particular example shown in FIG. 1 is based on the Global System for Mobile communications (GSM) standard; however, those skilled in the art will recognize that the architecture is generic and can be used to describe other standards such as, for example, CDMA systems. In a wireless network 100, a user device 10 is a location-enabled mobile station fully capable of communication with a GSM network 12 over the standard air interface. The mobile station (MS) 10 also includes a GPS receiver that is capable of acquiring and measuring signals from GPS satellites. The mobile station 10 is referred to as GSM-GPS-MS 10. Those skilled in the art, however, will appreciate that principles of the invention may be applied within other types of mobile or wireless devices that are location-enabled, such as, for example, pagers, laptop computers, personal digital assistants (PDAs), and other wireless devices. In addition, various embodiments of the invention may utilize other types of positioning receivers, such as, for example, GPS receivers, Assisted-GPS receivers (A-GPS), and other positioning receivers. Although GPS is described as an example, other satellite-based systems could be used, such as, for example, GLONASS, GALIEO, and the like. The GSM-GPS-MS 10 is described in greater detail with reference to FIG. 2.

A Mobile Location Center (MLC) 14 is responsible for obtaining GPS data and translating them into a format required by the GSM-GPS-MS 10. A GPS receiver 16 communicates directly with the MLC 14. The GPS receiver 16 acquires the GPS data and demodulates transmitted navigation messages containing ephemeris and clock corrections for the respective satellites. The GPS receiver 16 is required to collect several seconds of GPS data transmitted from the GPS satellites. The GPS data is transmitted at 50 bps and is divided into 1500 bit frames and 300 bit sub-frames. The MLC 14 has access to GPS database 18 which stores GPS data transmitted from the GPS satellites. The GPS data stored in the GPS database 18 is subsequently forwarded to the GSM-GPS-MS 10.

Furthermore, the MLC 14 has access to cell database 28, which contains coordinates of all cell sites that are in the geographic area served by the MLC 14. FIG. 1 further illustrates standard GSM network elements such as, for example, Mobile Switching Center (MSC)/Visitor Location Register (VLR) 15, a Base Station Controller 22, and Base Transceiver Station (BTS) 20. Another element in the network shown in FIG. 1 is a GPS receiver 24 attached to each BTS 20. The main purpose of the GPS receiver 24 is to provide the BTS 20 with an accurate time reference such that the BTS 20 can relate air-interface timing to GPS time.

FIG. 2 illustrates a block diagram of a GSM-GPS mobile station 10 in further detail. The GSM-GPS-MS 10 includes a GSM antenna 202 and a GSM receiver 204. The GSM receiver 204 includes a radio-frequency (RF) section 206, a digital section 207, a detector 208, and a digital-to-analog converter (DAC) 210. The GSM-GPS-MS 10 also includes a GPS antenna 212, an amplification and filter section 214, and a GPS receiver 216. The GPS receiver 216 includes a GPS RF section 218, a GPS data demodulation unit 220, and a GPS clock 222. For example, the GPS data demodulation unit 220 may be implemented in a digital signal processing (DSP) unit.

The GSM-GPS-MS 10 also includes an oscillator 224. The oscillator 224 produces a signal 226 having a particular frequency to drive the GSM receiver 204 as well as the GPS receiver 216. The oscillator 224 may be, for example, set to 13 MHz. The oscillator 224 may be, for example, a voltage controlled oscillator (VCXO). One objective of using the VCXO is to reduce costs, since the VCXO is relatively inexpensive. In addition, since VCXO is a calibrated oscillator, the VCXO may be utilized to demodulate GPS data from GPS satellites.

The oscillator signal 226 is coupled to the radio frequency (RF) section 206 of the GSM receiver 204. The oscillator signal 226 is also coupled to the GPS clock 222 of the GPS receiver 216. The oscillator signal 226 provides a reference signal at a reference frequency of, for example, 13 MHz. The frequency of the oscillator 224 is dependent on temperature and a frequency channel of the GSM-GPS-MS 10. The frequency of the oscillator 224 may fluctuate due to, among other things, temperature variation and phase jitters of the oscillator 224.

The GPS antenna 212 receives radio-frequency (RF) signals from in-view GPS satellites. It should be understood that any reference to the geographical location of the GPS-GSM-MS 10 is more particularly a reference to the location of the GPS antenna 212. The RF-GPS signal is transmitted from the GPS antenna 212 to the amplification and filter section 214. For example, the amplification and filter section 214 may include a low noise amplifier and filter circuitry. The amplification and filter section 214 separates and amplifies low level RF-GPS signals and noise from the RF-GPS signals received by the GPS antenna 212. The amplification and filter section 214 may be, for example, a separate device or packaged together with the GPS receiver 216 in a single chip package. The GPS RF section 218 receives the RF GPS signal from the amplification and filter section 214. The GPS RF section 218 downconverts and issues a sampled GPS signal at a lower frequency to the GPS data demodulation unit 220. The sampled GPS signal simultaneously includes carriers modulated by the GPS data bits spread by a pseudorandom (PRN) code from each of the in-view GPS satellites.

The GPS receiver 216 itself may operate based on a clock signal derived from the oscillator 224. Since the data rate for the RF GPS signals is different from that of the GSM signals, the reference clock frequencies required for the two receivers are different. The output of the oscillator 224 may be communicated to a GPS clock 222. The GPS clock 222 generates a GPS reference clock signal which may be different from the reference clock signal 226 generated by the oscillator 224. The output of the GPS clock 222 may be communicated to the GPS data demodulation unit 220. The GPS clock 222 provides the reference clock signal to the GPS data demodulation unit 220 and the GPS RF section 218. The GPS RF section 218 uses the reference clock signal to down-convert and sample the RF GPS signals.

The GPS data demodulation unit 220 typically includes several signal generators and correlators (not explicitly shown). The signal generators use the reference clock signal 226 as a time base for generating an internal receiver timer, clocking signals, and internal GPS replica signals. The correlators provide correlation data for the correlation between the internal GPS replica signals and the sampled GPS signal. The replica signals replicate the PRN codes for each of the GPS satellites that the GSM-GPS-MS 10 is tracking or attempting to acquire.

The GSM antenna 202 receives an RF signal transmitted according to the GSM standard. The RF signal includes frame synchronization portions and data portions from a transmitting base station 201. The RF signal is passed to the RF section 206 of the GSM receiver 204. The RF section 206 selects a signal having a certain high frequency corresponding to a specific GSM RF channel from signals received by the GSM antenna 202 and amplifies the selected signal. The selected signal is further multiplied by a local oscillator signal. The local oscillator signal is produced by a frequency generator (not explicitly shown) in the RF section 206. The local oscillator signal is based upon the reference frequency signal 226 (generated by the oscillator 224) and information of the frequency channel the GSM receiver is tuned to. The selected signal is down converted from a high frequency signal to a low frequency (baseband) signal for further processing such as, for example, demodulation in a baseband or digital section 207 of the GSM receiver 204. The demodulated voltage values are outputted from the digital section 207 to the detector 208 for reception data processing and frequency and/or phase correction.

The GSM receiver 204 may acquire and lock on to a clock frequency and/or phase of the transmitting base station 201. Once registered to the clock frequency and/or phase of the transmitting base station 201, the GSM receiver 204 may measure the degree of frequency and/or phase offset between a clock signal at the base station frequency derived from the oscillator signal 226 and the clock frequency and/or phase of the transmitting base station 201. The frequency and/or phase offset may be tracked to a fairly high accuracy, since cellular or other base stations often maintain accurate Cesium or other clock references.

The detector section 208 within the GSM receiver 204 determines an error between the frequency and/or phase of the received signal from the transmitting base station 201 and the frequency and/or phase of the clock signal at the base station frequency derived by the RF section 206 from the oscillator signal 226. A comparison signal (not shown) is thus a clock signal at the same frequency as that of the transmitting base station 201. The clock signal or comparison signal is derived by the RF section 206 from the oscillator signal 226. The RF section 206 derives the comparison signal at the transmitting base station 201 in a frequency synthesizer part (not shown) by mixing or multiplying a local oscillator signal with the clock signal. If a frequency and/or phase error exists, the detector 208 determines a correction data to correct the frequency and/or phase error between the received signal and the derived signal and outputs the correction data to a digital-to-analog converter (DAC) 210.

The DAC 210 performs digital-to-analog conversion of the correction data corresponding to the frequency and/or phase offset between the clock signal at the base station frequency derived from the oscillator signal 226 and the frequency and/or phase of the transmitting base station 201 to generate an analog output signal for the oscillator frequency and/or phase correction, thereby correcting the frequency and/or phase of the oscillator 224. The frequency and/or phase of the oscillator signal 226 must track the frequency and/or phase of the cellular signal received from the wireless network 100. As will be appreciated by those having skill in the art, a rate of change of the frequency and/or phase of the oscillator 226 may vary according, for example, to a speed of travel of the GSM-GPS-MS 10. The oscillator 224 is periodically calibrated by the detector 208 utilizing, for example, an automatic frequency and/or phase correction (AFC) algorithm. The detector 208 may be, for example, an automatic frequency control (AFC) circuit that locks to the frequency and/or phase of a carrier of the RF signal. The AFC algorithm causes a phase shift in the oscillator signal 226. Due to the periodic calibration of the oscillator 224, the GPS demodulation circuitry (not explicitly shown) is unable to determine if a change has occured in the GPS satellite data or the reference clock signal from the GPS clock 222. Thus, the GPS data demodulation unit 220 may demodulate erroneous data.

In order to prevent the GPS demodulation circuitry from demodulating erroneous data, the detector 208 outputs a control signal 228 to the GPS data demodulation unit 220. The control signal 228 provides an indication to the GPS data demodulation unit 220 that a frequency and/or phase update is being performed by the detector 208. The control signal 228 may also provide an indication to the GPS receiver 216 of a magnitude of a frequency and/or phase correction. By providing the magnitude of the frequency and/or phase correction, the control signal 228 enables the GPS receiver 216 to ascertain a level of disruption in the GPS satellite data due to changes in the reference clock signal. The control signal 228 may further indicate that the GPS receiver 216 is required to make adjustments to minimize the effect of the change in the GPS satellite data or the reference clock signal. More specifically, the control signal 228 indicates when the frequency and/or phase of the oscillator 224 is to be corrected by the detector 208. The control signal 228 enables the GPS data demodulation unit 220 to discard GPS satellite data when the frequency and/or phase update is being performed. During the time when the frequency and/or phase update is being performed by the detector 208, the GPS data demodulation unit 220 is made aware of the frequency and/or phase update via the control signal 228 after which the GPS data demodulation unit 220 discontinues satellite-data demodulation. The control signal 228 also provides an indication of the duration of the frequency and/or phase update and the magnitude of the frequency and/or phase update. The detector 208 includes a frequency control circuit for frequency and/or phase locking to the RF signal.

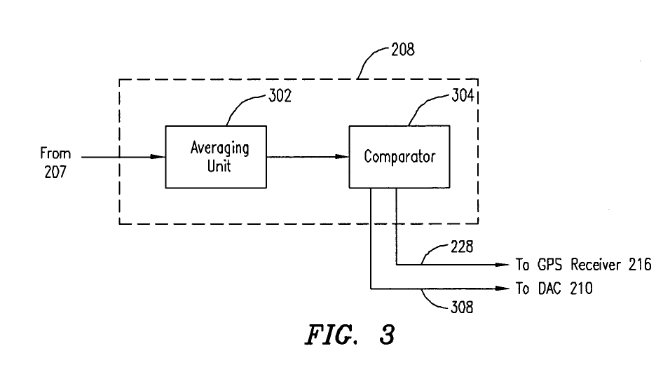

FIG. 3 illustrates in further detail a block diagram of the detector circuit 208. The detector circuit 208 includes an averaging unit 302 and a comparator 304. The averaging unit 302 receives a demodulated output voltage signal from the digital section 207 of FIG. 2 as the reception data. The averaging unit 302 determines an average of frequency and/or phase errors as a variation in voltage value. To detect the variation in voltage value, the comparator 304 compares the average of the frequency and/or phase offset determined by the averaging unit 302 with a predetermined value. The compared result is a digital signal 308 outputted to the DAC 210. The comparator 304 further produces the control signal 228 and outputs the control signal 228 to the GPS data demodulation unit 220 in the GPS receiver 216. The control signal 228 may be for example, identical to a digital signal 308 from the comparator 304 to the DAC 210 or a difference signal between the digital signal 308 and the correction data previously received by the DAC 210. The type of signal that is used is dependent upon hardware implementations for the receivers. The difference signal may be advantageous to use if the GPS and the GSM receivers are implemented in separate hardware units. However, the identical digital signal may be advantageous to use if the GPS and the GSM receivers are implemented in the same hardware unit. The averaging unit 302 and the comparator 304 may be implemented, for example, in hardware, as a software algorithm, or as a combination thereof.

According to an alternate embodiment, the control signal 228 may be used to indicate phase changes due to AFC updates in the process of tracking a low GPS signal level when the GPS receiver 204 cannot decode data due to low signal level but can only hear the GPS carrier signal. In such cases, GPS phase changes are looked for in the GPS signal. The control signal 228 can be used to distinguish between phase changes in the GPS signal against phase changes in the oscillator signal 226.

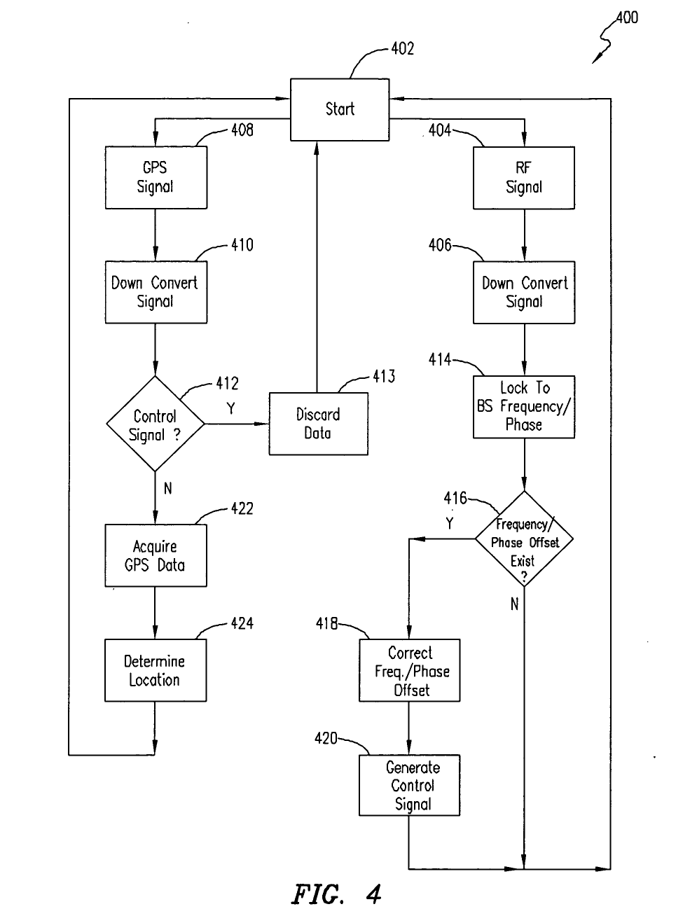

FIG. 4 illustrates in detail a process flow 400 for reducing a time to receive satellite data, such as, for example, reducing a time to fix (TTF). TTF may be, for example, a time to first fix (TTFF) or any subsequent fixes performed. TTFF is the time required by the wireless device, for example, the GSM-GPS-MS 10, to provide an accurate geographical location from the point in time of initialization of the GSM-GPS-MS 10. The initialization of the GSM-GPS-MS 10 can be, for example, in a “cold start” mode or a “warm start” mode. In the “cold start” mode, the GSM-GPS-MS 10 does not have knowledge of one or more of its own approximate location, current time, and satellite transmitted data. However, in the “warm start” mode, the GSM-GPS-MS 10 may have information about current time and general location information.

Although steps of the flow 400 are depicted in a particular sequence, it will be appreciated by persons of ordinary skill in the art that certain steps of the process need not necessarily follow a strict sequence but can be rearranged and/or performed simultaneously. The flow 400 starts at step 402. At step 404, the GSM antenna 202 receives the RF signal transmitted according to the GSM standard. At step 406, the RF section 206 downconverts the received RF signal and samples the downconverted RF signal. At step 414, the GSM receiver 204 locks onto a clock frequency and/or phase of the transmitting base station 201 and, once locked onto the clock frequency and/or phase of the transmitting base station 201, the GSM receiver 204 measures the degree of frequency and/or phase offset between the frequency and/or phase of the clock signal (or comparison signal) derived from the oscillator signal 226 and the clock frequency and/or phase of the transmitting base station 201. At step 416, it is determined if a frequency and/or phase offset exists between the clock signal derived from the oscillator signal 226 and the clock frequency and/or phase of the transmitting base station 201. If it is determined that a frequency and/or phase offset does not exist, the flow 400 proceeds to step 402.

However, if it is determined at step 416 that a frequency and/or phase offset exists between the frequency and/or phase of the clock signal derived from the oscillator signal 226 and the clock frequency and/or phase of the transmitting base station 201, the process is continued at step 418. At step 418, the detector 208 determines frequency and/or phase correction data and outputs the correction data to a digital-to-analog converter (DAC) 210. At step 420, the detector 208 generates a control signal 228 and outputs the control signal 228 to the GPS receiver 216 and the flow 400 returns to step 402.

At step 408, the GPS antenna 212 receives a RF GPS signal from the in-view GPS satellites. At step 410, the GPS RF section 218 downconverts the RF GPS signal and samples the downconverted RF GPS signal. At step 412, it is determined if a control signal 228 has been received by the GPS data demodulation unit 220. The control signal 228 provides an indication to the GPS data demodulation unit 220 that the frequency and/or phase of the oscillator signal 226 is to be corrected by the detector 208. The control signal 228 provides an indication to the GPS data demodulation unit 220 that a frequency and/or phase update is being performed by the detector 208. Alternatively, the control signal 228 may also provide an indication to the GPS receiver 216 of a magnitude of a frequency and/or phase correction. By providing the magnitude of the frequency and/or phase correction, the control signal 228 enables the GPS receiver 216 to ascertain a level of disruption in the GPS satellite data due to changes in the reference clock signal. The control signal 228 may further allow the GPS receiver 216 to make adjustments to minimize the effect of the change in the GPS satellite data or the reference clock signal. More specifically, the control signal 228 indicates when the frequency and/or phase of the oscillator 224 is to be corrected by the detector 208. The control signal 228 directs the GPS data demodulation unit 220 to discard GPS satellite data while the frequency and/or phase update is being performed. This process of discarding GPS satellite data is performed in order to prevent the GPS demodulation circuitry from demodulating erroneous data caused by the periodic calibration of the oscillator 224. The GPS data itself is transmitted at 50 bits per second and is divided into 1500 bit frames and 300 bit sub-frames. The transmission of the frames is repeated at various intervals. Each GPS word is 10 bits and depending upon the accuracy of the control signal 228, either a bit, word, frame or sub-frame can be identified as being erroneous and should be discarded. The GPS receiver may fill in gaps the next time the same data is transmitted and the control signal 228 is not active. For example, the data may be the ephemeris parameters, which is transmitted in sub-frames 2 and 3 and repeated approximately every 30 seconds.

If it is determined that the control signal 228 has not been received by the GPS data demodulation unit 220, the flow 400 proceeds to step 422, where the GPS data is acquired. At step 424, the GSM-GPS-MS 10 receiver location is determined or a measurement of satellite pseudo ranges is provided.

If it is determined at step 412 that the control signal 228 has been received at the GPS data demodulation unit 220, the flow 400 proceeds to step 413. At step 413, GPS satellite data is discarded while the frequency and/or phase update is being performed. The data that is discarded is the smallest logical data block (i.e., either a bit, word, sub-frame or frame) in which the satellite data is being received at the time and found erroneous. The flow 400 proceeds to step 402 where the process is repeated. In addition, intermediate stages may also be present even though not explicitly defined herein. For example, decoding satellite data blocks, such as, for example, almanac data or navigation model blocks of data may be discarded while the control signal 228 is received by the GPS data demodulation unit 220.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof.

The previous Detailed Description is of embodiment(s) of the invention. The scope of the invention should not necessarily be limited by this Description. The scope of the invention is instead defined by the following claims and the equivalents thereof.

What is claimed is:

1. A location-enabled wireless device comprising:
a wireless receiver;
a positioning-signal receiver;
an oscillator adapted to output a reference-frequency signal to the wireless receiver and the positioning-signal receiver; and
a detector adapted to output a control signal upon detection of at least one of a frequency error and a phase error between wireless signals and the reference-frequency signal.

2. The location-enabled wireless device of claim 1, wherein the detector is adapted to output the control signal to a data demodulation unit of the positioning-signal receiver.

3. The location-enabled wireless device of claim 2, wherein the control signal provides an indication to the data demodulation unit that the reference-frequency of the oscillator is being updated.

4. The location-enabled wireless device of claim 2, wherein the control signal provides an indication to the data demodulation unit of a magnitude of the at least one of the frequency error and the phase error.

5. The location-enabled wireless device of claim 3, wherein the data demodulation unit is adapted to discontinue demodulation of positioning signals during a reference-frequency update.

6. The location-enabled wireless device of claim 1, wherein the detector comprises an automatic frequency control (AFC) circuit.

7. The location-enabled wireless device of claim 6, wherein the detector is adapted to periodically update the reference-frequency signal of the oscillator.

8. The location-enabled wireless device of claim 1, wherein the oscillator comprises a voltage-controlled oscillator (VCXO).

9. The device of claim 1, wherein the location-enabled wireless device comprises a mobile device.

10. The device of claim 1, wherein the positioning-signal receiver comprises a global positioning system (GPS) receiver.

11. The device of claim 1, wherein the detector is adapted to output the control signal to the positioning-signal receiver.

12. The device of claim 2, wherein the data demodulation unit comprises a digital signal processor (DSP).

13. A method of reducing a time to fix in a location-enabled wireless device, the method comprising:
receiving wireless signals;
receiving positioning signals;
outputting of a reference-frequency signal to a wireless receiver and a positioning-signal receiver;
responsive to detection of at least one of a frequency error and a phase error between wireless signals and the reference-frequency signal, outputting a control signal; and
wherein the control signal provides an indication that the reference-frequency signal is being updated.

14. The method of claim 13, wherein the control signal further provides an indication of a magnitude of the at least one of the frequency error and the phase error.

15. The method of claim 13, further comprising discontinuing demodulation of the positioning signals during a reference-frequency update.

16. The method of claim 13, wherein the step of detection further includes periodically updating the reference-frequency signal.

17. The method of claim 13, wherein the step of receiving positioning signals is in accordance with a global positioning system (GPS).

18. The method of claim 13, further comprising:
receiving the control signal; and
responsive to receipt of the control signal, discontinuing demodulation of positioning signals.

19. The method of claim 18, wherein the control signal is received by the positioning-signal receiver.

20. The method of claim 18, wherein the control signal is received by a data demodulation unit.

21. The method of claim 20, wherein the data demodulation unit comprises a digital signal processor (DSP).

22. The method of claim 13, wherein the step of outputting is performed by a detector.

23. The method of claim 22, wherein the detector comprises an automatic frequency control (AFC) circuit.
